(19) United States
(12) Patent Application Publication
(10) Pub. No.: US 2025/0346254 A1
(43) Pub. Date: Nov. 13, 2025

(54) MULTI-MODAL LARGE LANGUAGE MODEL WITH TOKENIZED OBJECT-LEVEL KNOWLEDGE FOR AUTONOMOUS DRIVING

(71) Applicant: NVIDIA Corporation, Santa Clara, CA (US)

(72) Inventors: Boyi Li, Berkeley, CA (US); Ran Tian, Santa Clara, CA (US); Yuxiao Chen, Campbell, CA (US); Xinshuo Weng, North York (CA); Yue Wang, Los Angeles, CA (US); Boris Ivanovic, Mountain View, CA (US); Marco Pavone, Stanford, CA (US); Edward Schmerling, Seattle, WA (US)

(21) Appl. No.: 18/955,615

(22) Filed: Nov. 21, 2024

Related U.S. Application Data
(60) Provisional application No. 63/644,021, filed on May 8, 2024.

(51) Int. Cl. B60W 60/00; G06V 10/764; G06V 10/82; G06V 20/58; G06V 20/70

(52) U.S. Cl. CPC B60W 60/0015; G06V 10/765; G06V 10/82; G06V 20/58; G06V 20/70

(57) ABSTRACT

Apparatuses, systems, and techniques for enhancing autonomous driving systems. In at least one embodiment, visual input corresponding to an observable environment is tokenized into object-level knowledge and provided to a large language model (LLM). Object-level tokens are processed by the LLM to enhance autonomous vehicle route-planning, reducing trajectory error and decreasing collision rates.

### CLAIM OF PRIORITY

This application claims the benefit of U.S. Provisional Application No. 63/644,021 titled “MULTI-MODAL LARGE LANGUAGE MODEL WITH TOKENIZED OBJECT-LEVEL KNOWLEDGE FOR AUTONOMOUS DRIVING,” filed May 8, 2024, the entire contents of which are incorporated herein by reference.

### BACKGROUND

The autonomous driving industry is increasingly pursuing end-to-end learning from sensory inputs to reduce human inductive bias in system design. Despite the remarkable progress, end-to-end models inherently suffer from severe performance degradation in long-tail scenarios. For example, state-of-the-art end-to-end autonomous driving planners often fail to navigate temporary construction sites and react too aggressively to jaywalkers; even simple rule-based planners can significantly outperform high-capacity end-to-end models in these long-tail scenarios. This motivates recent efforts to fine-tune Large Language Models (LLMs) into autonomous vehicle planners, aiming to leverage the benefits of both high-capacity models and the common-sense reasoning abilities that emerge from world-knowledge training.

LLM-based planners, in their simplest form, depend on textual scene descriptions as prompts, making their performance highly reliant on the quality and detail of these descriptions. Detailed prompts require extensive engineering and generate many tokens for the LLM to process. Conversely, evaluations show that simple, heuristic prompts do not tap into the common-sense reasoning abilities of LLMs due to insufficient scene understanding. As a result, Multi-Modal Large Language Models (MM-LLMs), which naturally integrate various data modalities beyond text, are emerging as promising foundations for developing autonomy stacks in autonomous vehicles.

The predominant approach has been to leverage pre-trained encoders (typically pre-trained using visual text alignment) to extract features from the sensory inputs, followed by a querying transformer that uses latent queries to tokenize the features into dense latent tokens and feed them to the LLMs. Training an effective scene tokenizer (encoder and querying transformer) often requires billions of question-answer pairs (QAs), even for tasks that are much less complicated than autonomous driving. However, current MM-LLM datasets for autonomous driving typically contain fewer than one million QAs. Consequently, these models often exhibit poor performance in reasoning and planning tasks due to a lack of scene understanding and grounding capability. The key challenge is to enable the scene tokenizer to extract informative and structured information that can unlock the common-sense reasoning ability of the LLM in a low-data regime.

### SUMMARY

Embodiments of the present disclosure relate to a Multi-Modal Large Language Model (MM-LLM) with tokenized object-level knowledge for autonomous driving. Systems and methods are disclosed that tokenize the visual input into object-level knowledge and utilize various types of questions, including perception, reasoning, and planning questions, thereby enabling better utilization of reasoning capabilities of LLMs to enhance autonomous vehicle planning.

### BRIEF DESCRIPTION OF THE DRAWINGS

The present systems and methods for a Multi-Modal Large Language Model (MM-LLM) with tokenized object-level knowledge for autonomous driving are described in detail below with reference to the attached drawing figures, wherein:

FIG. 1A illustrates a block diagram of a framework suitable for use in implementing some embodiments of the present disclosure;

FIG. 1B illustrates a block diagram of a tokenizer suitable for use in implementing

some embodiments of the present disclosure;

FIGS. 2A-2C illustrate examples of visual question-answering pairs in a dataset, in accordance with an embodiment;

FIG. 3A illustrates a block diagram of a model suitable for use in implementing some embodiments of the present disclosure;

FIG. 3B illustrates functional modules/components suitable for use in the model as shown in FIG. 3A;

FIG. 3C illustrates a flowchart of a method for training a model, in accordance with an embodiment;

FIG. 3D illustrates a flowchart of a method for motion planning for an autonomous vehicle, in accordance with an embodiment;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

Systems and methods are disclosed herein that relate to a Multi-Modal Large Language Model (MM-LLM) with tokenized object-level knowledge for autonomous driving, and in particular, to the enhanced utilization of LLM reasoning capabilities that address the problem of data scarcity in long-tail scenarios.

A vision-language model (VLM) is a type of MM-LLM that combines the capabilities of computer vision and natural language processing (NLP) to achieve tasks that require understanding of both modalities. In at least one embodiment, a VLM receives visual input from sensory data of an autonomous vehicle, along with other types of visual information (e.g., maps and/or symbolic representations) as observations of an environment.

In at least one embodiment, a pre-trained tokenizer is utilized to perform object-centric tokenization, via which an observable environment is tokenized into a few object-level tokens, with each token representing a relevant object in the scene. The object-level tokens are much more informative and easier for the LLM to interpret compared to unstructured dense tokens. In at least one embodiment, the pre-trained tokenizer utilizes a transformer-based end-to-end autonomous vehicle (AV) planning model, in contrast to a vision encoder (e.g. CLIP).

In at least one embodiment, training of the VLM is facilitated by a specifically constructed dataset including perception, reasoning, and planning question-answering pairs (QAs). In certain embodiments, the QAs can be semi-automatically generated based on objects identified in the tokenization process. The QAs in the dataset are used to train the VLM at various stages. In at least one embodiment, the perception QAs are used to train the adapter to achieve enhanced representation alignment. In at least one embodiment, the reasoning QAs and planning QAs are used together to train the model for enhanced reasoning alignment, allowing the model to understand the criticality of the objects in planning tasks. In at least one embodiment, the planning QAs are used to train the model for enhanced planning performance.

In at least one embodiment, an end-to-end driving model is provided. The end-to-end driving model includes a pre-trained tokenizer and a VLM. The pre-trained tokenizer performs object-level tokenization to provide object level tokens, which are subsequently provided to the VLM, enabling better utilization of LLM reasoning capabilities and thereby enhancing autonomous vehicle planning in long-tail scenarios. The object-level tokens are much more informative and easier for the LLM to interpret compared to unstructured dense tokens. In certain embodiments, the model utilizes additional tokens, such as scene-level tokens and/or traffic agent tokens for enhanced planning performance.

In at least one embodiment, an end-to-end driving model effectively alleviates data scarcity and inefficient tokenization by producing condensed and semantically enriched representations of a scene. These representations are optimized for LLM planning compatibility through deliberate representation and reasoning alignment training stages. Results produced by one embodiment of an end-to-end driving model demonstrate that the VLM excels in grounding, reasoning, and planning capabilities, outperforming existing frameworks with a 27% reduction in trajectory L2 error and a 39% decrease in collision rates in long-tail scenarios.

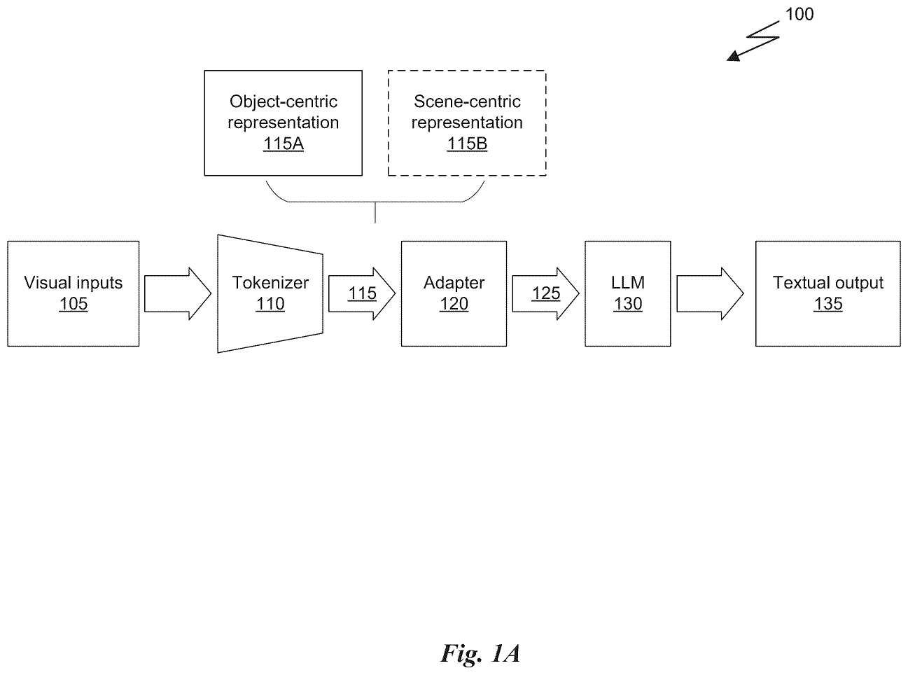

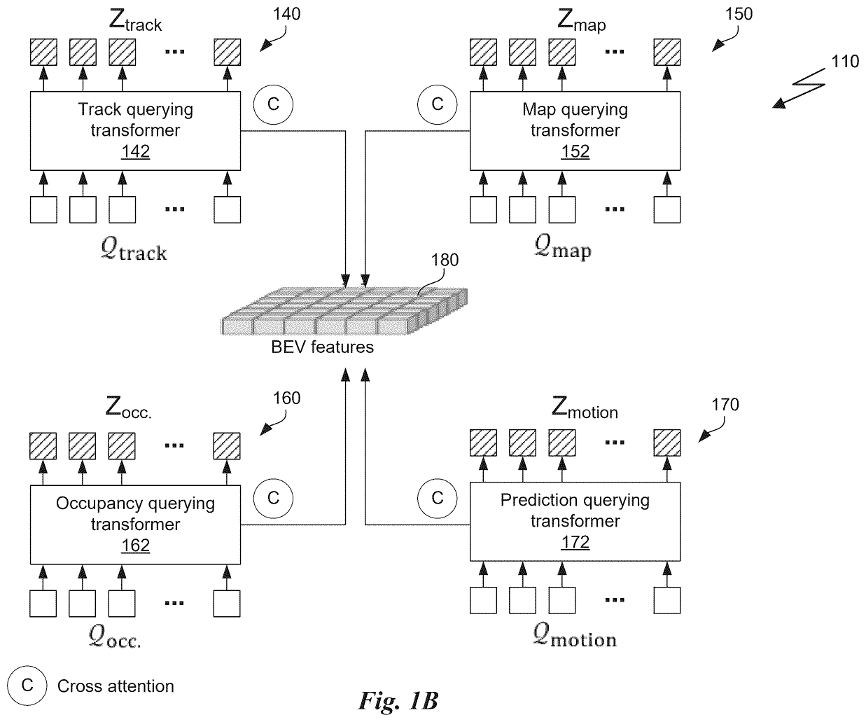

FIG. 1A illustrates a block diagram of a framework 100 according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the framework 100 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

As shown in FIG. 1A, the framework 100 includes a tokenizer 110, an adapter 120, and a large language model (LLM) 130. In certain embodiments, a transformer-based model is used as the tokenizer 110. The tokenizer 110 receives, as input, visual data 105, and generates, by processing the visual data 105, a plurality of visual tokens 115. The visual input 105 includes, pictures, video frames, map representations, symbolic representations, or other suitable representations of a scene. In at least one embodiment, certain representations of the scene, such as symbolic representations, can be derived from the visual input 105, for example, by using a separate detection system. In this context, a scene refers to the environment or setting represented in a picture or video frame, which can include various objects.

The visual tokens 115 include, in particular, a plurality of object-centric tokens 115A. The object-centric tokens 115A encode rich spatial, temporal, and semantic information directly associated with relevant objects in the scene. For example, objects in the scene can include one or more traffic agents and/or map (or road) elements. A traffic agent refers to any entity that moves within the traffic environment and interacts with an autonomous vehicle (e.g., an ego vehicle), such as, e.g., another vehicle, a pedestrians, an animal, etc. A map/road element refers to any component or feature that is part of a detailed map used by autonomous vehicles to navigate their environment, such as, e.g., a lane, an intersection, a roundabout, a lane boundary, a road sign, etc. Each object-centric token 115A corresponds to an object identified in the scene. An identified object in the scene can be associated with a segmentation in an image frame generated by an end-to-end driving model.

The visual tokens 115 can further include a plurality of scene-centric tokens 115B. The scene centric tokens 115B encode spatial, temporal, and semantic information associated with different portions in the scene. For example, prior to encoding, an image frame of a scene can be divided into a plurality of image patches according to a predefined rule (e.g., predetermined dimensions of the image patches). As such, each image patch contains a portion of the scene, which includes mixed information (both local and global) from various objects and background.

The adapter 120 receives the visual tokens 115 from the tokenizer 110 and aligns the visual tokens 115 in a text embedding space to produce corresponding aligned tokens 125. The large language model (LLM) 130 receives the aligned tokens 125 from the adapter 120, processes the aligned tokens 125 to extract information, and generate predictions. In at least one embodiment, the framework 100 outputs textual output 135. In at least one embodiment, various types of outputs (e.g., visual, audio, etc.) can be generated and/or output by the framework 100.

The tokenizer 110 is used to tokenize the scene into a plurality of visual tokens 115. In at least one embodiment, the tokenizer 110 identifies, based on the visual data 105 obtained from an environment of the autonomous device, a plurality of objects in the environment, and generates, for the plurality of identified objects, a plurality of object level visual tokens. In at least one embodiment, the tokenizer 110 is a transformer-based model, i.e. a neural network architecture that incorporates one or more transformer blocks, each transformer block including an attention mechanism and a multi-layer perceptron (MLP). The tokenizer 110 is trained with object-centric driving tasks to provide object-level tokens (e.g., the object-centric representations 115A). Each object-level token encodes semantic, geometry, and dynamic information corresponding to an individual object, thereby improving information density per-token. The tokenizer 110 can leverage existing end-to-end driving models, which are trained on tasks such as detection, tracking, and segmentation, and are thus already optimized to encode rich spatial, temporal, and semantic information directly associated with relevant objects.

The tokenizer 110 generates the plurality of object-level tokens 115A represented in a latent token embedding space, where each token is embedded as a vector (or a set of vectors). The vectors encode meaningful information about the object associated with the tokens. The latent token embedding space is high-dimensional, allowing for nuanced representations of the tokens.

In certain embodiments, in addition to the object-level tokens, unstructured scene-level latent tokens (e.g., the scene-centric representations 115B) learned from scratch can be optionally included to compensate for missing information, such as weather conditions.

In certain embodiments, the tokenizer 110 further provides scene-level tokens (e.g., the scene-centric representations 115B).

The adapter 120 aligns the latent token embedding space with a text embedding space in order for the LLM 130 to understand and extract information. In certain embodiments, the adapter 120 for token alignment includes learnable layers, such as feedforward neural networks. The learnable layers can be optimized during fine-tuning, allowing the adapter 120 to capture alignment patterns between tokens efficiently without modifying the main model architecture. A wide range of Question-Answer (QA) tasks are performed to train the adapter 120 to align the tokens 115, paving the road for the subsequent behavior planning task. The alignment is facilitated by specifically designed questions, which follow a specific logic and format, enabling the mapping of token features and their relationships from the latent token embedding space to the text embedding space. As a result, the vectors associated with the object-level tokens in the latent token embedding space are transformed into corresponding vectors in the text embedding space.

The aligned tokens 125, which can include object-level tokens 115A and optionally scene-level tokens 115B, are fed into the LLM 130. The LLM 130 is trained to extract information from the aligned tokens 125 and make decisions based on its common-sense reasoning abilities.

FIG. 1B illustrates a block diagram of a tokenizer 110, according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the tokenizer 110 is within the scope and spirit of embodiments of the present disclosure.

As shown in FIG. 1B, the tokenizer 110 includes a parallelized modular autonomous vehicle stack that encompasses a diverse set of modules for the co-training of bird's-eye view (BEV) features 180 from multi-view video input. The set of modules includes an object tracking module 140, a mapping module 150, an occupancy prediction module 160, and a motion prediction module 170. Each module includes a querying transformer (e.g., the track querying transformer 142, the map querying transformer 152, the occupancy querying transformer 162, or the prediction querying transformer 172) that uses latent queries ( [symbol] ) to attend to the BEV features 180 and decode the corresponding task output (z). For example, in certain embodiments, the tokenizer 110 is pre-trained on object-centric and scene-centric tasks, including mapping, object tracking, occupancy prediction, and motion prediction. In object-centric tasks, each query ( [symbol] ) produces a latent token (z) that encodes information about a specific scene object.

In object tracking module 140, the object tracking query is represented by

$${Q}_{track}^{i}$$

that is trained to produce a token

$${z}_{track}^{i}$$

∈ [symbol] ^{1×256} that encodes object i's three-dimensional (3D) bounding box and semantic category. In the motion prediction module 170, the motion query is represented by

$${Q}_{motion}^{i}$$

that is trained to produce a token

$${z}_{motion}^{i}$$

∈ [symbol] ^{1×256} that encodes object i's potential dynamic behavior. In the occupancy prediction module 160, the occupancy query is represented by

$${Q}_{occ}^{i} .$$

that is trained to produce a token

$${z}_{occ}^{i} .$$

∈ [symbol] ^{1×256} that encodes the driving scene's future occupancy grids. In mapping module 150, the map query is represented by

$${Q}_{map}^{i}$$

that is trained to produce a token

$${z}_{map}^{j}$$

∈ [symbol] ^{1×256} that encodes the map element j's geometry and semantics (e.g., crossing area) information. Cross attention means that each transformer model attends to the overall extracted features during its feature extraction process. For each module, the query ( [symbol] ) attends to the BEV feature 180 through a series of operations within the transformer model (e.g., 140, 150, 160, or 170), producing the corresponding token z. One or more of these tokens can be used to represent a corresponding object (i) and/or a map element (j).

In certain embodiments, a non-map object token

$$( {z}_{agent}^{i} )$$

can be formed by concatenating the corresponding track token

$$( {z}_{track}^{i} )$$

and motion token

$$( {z}_{motion}^{i} ) ,$$

as:

$${z}_{agent}^{i} = {z}_{track}^{i} ⊕ {z}_{motion}^{i} . \qquad Eq . ( 1 )$$

The map token

$$( {z}_{map}^{j} )$$

is used as the map element token. To this end, non-map object tokens and map element tokens are aligned using different networks of the adapter 120. For example, the non-map object tokens are aligned using a multilayer perceptron (MLP) adapter network, while the map element tokens are aligned using another adapter network.

The LLM 130 receives the aligned tokens 125 from the adapter 120 and processes the input using a set of predefined queries to extract relevant information and generate an output for a requested task (e.g., a behavior planning task for autonomous driving).

The set of queries is defined as a sequence of structured questions capable of breaking down the answer to a complex question into multi-step reasoning, thereby enhancing the reasoning capability of the LLM comparing to conventional queries used by LLMs.

During training and evaluation of a VLM framework (e.g., the framework 100), a dataset is constructed including visual question-answering (QA) pairs that span the full stack of autonomous driving development. The visual QA pairs are also referred to as “QAs” in the present disclosure. Questions from the visual QAs are used in both the training and inference stages. Corresponding answers are prepared based on visual input as ground truth to optimize the model.

The QAs are designed for diverse objectives, including perception, behavior reasoning, and route-conditioned hierarchical planning. The QAs can be semi-automatically populated for the objects identified through tokenization, based on specifically designed underlying logic and generic templates.

Perception QAs are built to cover object semantics and dynamic behavior identification for scene understanding. In certain embodiments, object semantics include a type, category and/or two-dimensional (2D) location of the object, while dynamic behavior encompasses the future motion of the object. Furthermore, object-lane association QAs are created to enhance the model's understanding of map elements and objects' topological relationships to an ego vehicle. An ego vehicle is an example platform equipped with suitable sensors (e.g., cameras, laser scanning systems, etc.) to obtain the visual input 105.

Behavior reasoning QAs include two types of questions: object-level behavior analysis questions and scene-level critical object grounding questions. With object-level behavior analysis questions, the model is tasked with reasoning about whether an object is critical (e.g., likely to influence the ego vehicle's planning) and providing the corresponding rationale. With scene-level critical object grounding questions, the model is asked to predict the locations of critical objects in the ego vehicle's local frame. Behavior reasoning QAs aim to enable the model to understand context-dependent critical objects, thereby connecting the object tokens with the LLM to simplify the scene for downstream planning. In certain embodiments, the LLM can identify one or more critical objects among those corresponding to the object-level tokens after processing the behavior reasoning questions. This reasoning capability can be trained and/or optimized using the behavior reasoning QAs.

Route-conditioned hierarchical planning QAs guide the model to generate motion plans. Different from previous works that use the relative position of the ground-truth ego trajectory to define high-level commands (“keep forward” and “turn right/right”), the dataset is labeled to use road-level navigation signals as high-level commands, including: “keep forward along the current road,” “prepare to turn right/left at the next intersection,” “turn right/left at the intersection,” “left/right U-turn,” and “left/right 3-point turn.” Chain-of-thought reasoning is utilized to align the model's planning process and guide the model to progressively generate the driving plans in three steps. First, the model identifies the critical objects in the current driving scene, including their categories and 2D locations in the ego frame. Next, the model proposes the desired behavior mode, detailing interaction plans with the critical objects (e.g., overtake) and lane-level decisions (e.g., left lane change). Finally, the model generates a three-second motion plan (e.g., with six waypoints).

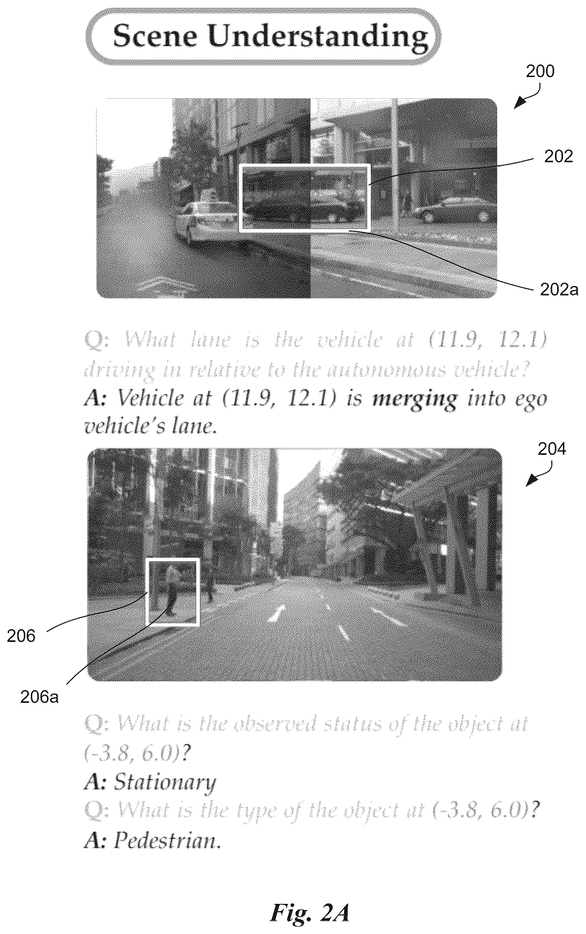

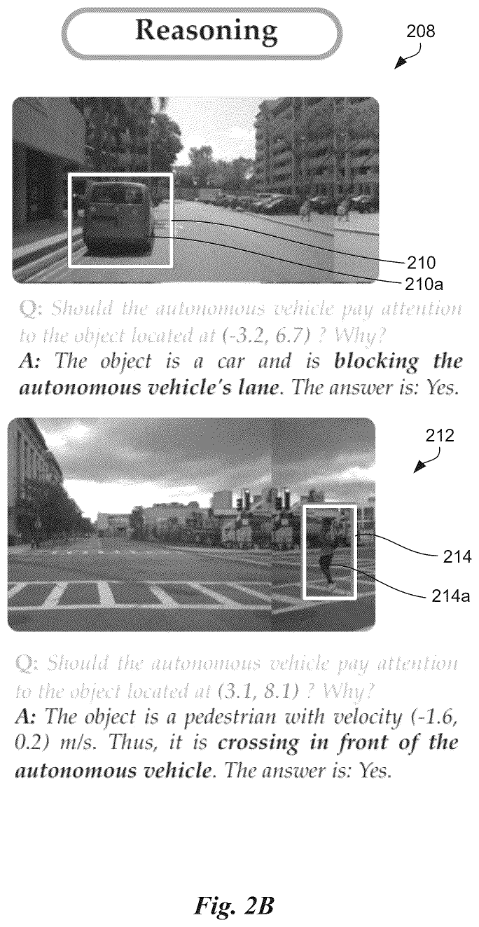

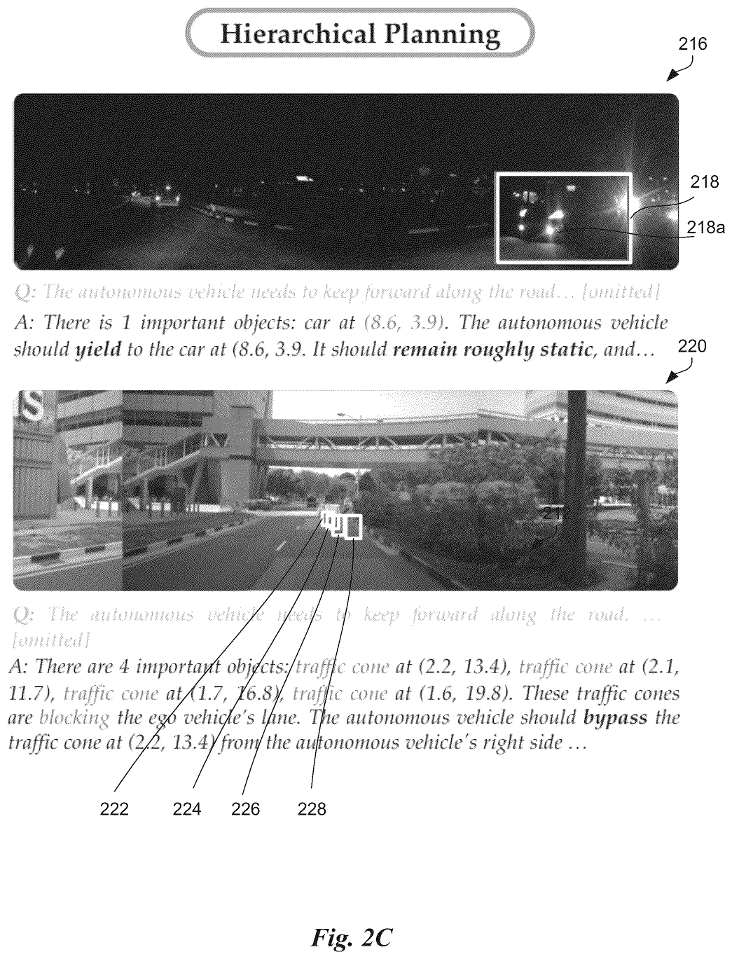

FIGS. 2A-2C illustrate examples of visual question-answering pairs in a dataset, in accordance with an embodiment.

FIG. 2A shows examples of perception QAs. For an object (e.g., a vehicle 202a) inside box 202 in image frame 200, one example question can be: “What lane is the vehicle at (11.9, 12.1) driving in relative to the autonomous vehicle?” The corresponding answering can be: “Vehicle at (11.9, 12.1) is merging into ego vehicle's lane.” As shown in this example, the coordinates (11.9, 12.1) can be inserted into a question template to construct a complete question (e.g., the question in this example). For example, the question template can be “What lane is the vehicle at [coordinates] driving in relative to the autonomous vehicle?” This question template can be triggered based on identifying an object as a vehicle through one or more other perception questions. These coordinates serve as an identifier associated with an object recognized from the visual input (e.g., an image frame). In certain embodiments, each object is associated with a set of coordinates that represent its location (e.g., in pixels) within a local frame.

For an object (e.g., a pedestrian 206a) inside box 206 in image frame 204, one QA pair includes the question: “what is the observed status of the object at (−3.8, 6.0)?” The corresponding answering is: “Stationary.” Another QA pair includes the question: “What is the type of the object at (−3.8, 6.0)?” The corresponding answering is: “Pedestrian.”

In certain embodiments, a set of perception questions, constructed based on templates incorporating corresponding identifying information, is applied to each token 125 input into the LLM 130, including both the aligned object-level tokens and scene-level tokens. The set of perception questions are constructed to query a wide spectrum of metrics of each object (and/or any portion of a scene), thereby allowing the model to gain comprehensive understanding of the scene, object semantics, dynamics, and more.

FIG. 2B shows examples of behavior reasoning QAs. For an object (e.g., a car 210a) inside box 210 in image frame 208, the question(s) can be: “Should the autonomous vehicle pay attention to the object located at (−3.2, 6.7)? Why?” The corresponding answering can be: “The object is a car and is blocking the autonomous vehicle's lane. The answer is: Yes.” The answering provides the reasoning that “[the object] is blocking the autonomous vehicle's lane,” which led to the answer “Yes.”

For an object (e.g., a pedestrian 214a) inside box 214 in image frame 212, the question(s) can be: “Should the autonomous vehicle pay attention to the object located at (3.1,8.1)? Why?” The corresponding answering can be: “The object is a pedestrian with velocity (−1.6, 0.2) m/s. Thus, it is crossing in front of the autonomous vehicle. The answer is: Yes.” In this example, “m/s” stands for meters per second. The answering provides the reasoning that “[the object] is crossing in front of the autonomous vehicle,” which led to the answer “Yes.”

The behavior reasoning QAs enable the model to learn the importance of each input token based on the reasoning. For example, through the behavior reasoning QAs, the model can identify one or more objects that are critical or likely to have significant impact on the autonomous vehicle's travel. In certain embodiments, the model can identify a critical object as one that receives the answer “Yes” to the question “Should the autonomous vehicle pay attention to the object located at [the object's coordinates]?” In certain embodiments, the model can determine that none of the identified objects are important.

FIG. 2C shows examples of route-conditioned hierarchical planning QAs. For an object (e.g., a car 218a) inside box 218 in image frame 216, the question(s) can be: “The autonomous vehicle needs to keep forward along the road. What objects are important for the autonomous vehicle's planning? What are these objects, their (x, y) locations? and how to interact with them? Please plan the autonomous vehicle's 3-second future trajectory using 6 waypoints, one every 0.5 second.” The corresponding answering can be: “There is 1 important object: car at (8.6, 3.9). The autonomous vehicle should yield to the car at (8.6, 3.9). It should remain roughly static, and its 3-second future trajectory is: [(−0.0,0.0), (−0.0,−0.0), (−0.0,−0.0), (−0.0,−0.0), (−0.0,−0.0), (−0.0,−0.0)].”

For objects (e.g., traffic cones) inside boxes 222-228 in image frame 220, the question(s) can be: “The autonomous vehicle needs to keep forward along the road . . . ” The corresponding answering can be: “There are 4 important objects: traffic cone at (2.2, 13.4), traffic cone at (2.1, 11.7), traffic cone at (1.7, 16.8), traffic cone at (1.6, 19.8). These traffic cones are blocking the ego vehicle's lane. The autonomous vehicle should bypass the traffic cone at (2.2, 13.4) from the autonomous vehicle's right side . . . ”

In certain embodiments, the model applies the route-conditioned hierarchical planning QAs to the critical object(s) to generate motion planning for the autonomous vehicle.

In the present disclosure, the training dataset can be labeled using road-level navigation signals as high-level commands, including “keep forward along the current road,” “prepare to turn right/left at the next intersection,” “turn right/left at the intersection,” “left/right U-turn,” and “left/right 3-point turn.”

In certain embodiments, a combination of heuristics and manual labeling is applied to annotate the interactions between the ego vehicle and the other traffic agents. Two types of categorical modes are used to describe (i) the lane-relationship between a traffic agent and the ego vehicle, and (ii) the relative motion between a traffic participant and the ego vehicle. The former is referred to as the agent-ego lane mode, while the latter is referred to as the homotopy mode. Agent-ego lane mode at a time step t encodes the topology relationship between the ego's current lane and the traffic agent's lane, including: LEFT, RIGHT, AHEAD, BEHIND, and NOTON, where NOTON describes that the traffic agent is not on any derivable lanes in the scene (e.g., a parked vehicle in a parking lot). To compute the agent-ego lane mode for each traffic agent, the lane on which each agent is located is first identified, and then the lane topology map is leveraged to annotate the agent-ego lane mode. The agent's center is projected onto the lane polyline, and the relative position of the agent's center in the local Frenet frame is used to determine its lane association. Homotopies describe the relative motion between a pair of agents shown in the video, including: [S, CW, CCW] (static, clockwise, counterclockwise). By combining agent-ego lane mode, homotopy, agent ground truth state information, and scene context information (e.g., the ego vehicle is located near an intersection), heuristics can be leveraged to annotate the interaction. For example, within a three-second horizon, a static object's agent-ego lane mode changes from AHEAD, to LEFT, to BEHIND, while the ego vehicle performs RIGHT-LANE-CHANGE, KEEP-LANE, then LEFT-LANE-CHANGE, indicating the ego vehicle overtakes that object from the ego vehicle's left side. In certain embodiments, human labelers can be involved to verify and correct interaction labels in the following categories: 1) bypass blocking traffic cones to navigate around a construction zone; 2) yield to pedestrians; 3) yield to vehicles; 4) overtake traffic agents via straddling the lane dividers; 5) overtake traffic agents via lane-change.

The dataset is utilized to train one or more learnable components in framework 100. For example, the learnable components include one or more tokenizers 110, adapter 120 (e.g., including one or more learnable networks), and/or LLM 130. The one or more learnable components in the framework 100 can be trained jointly and/or separately in different training stages.

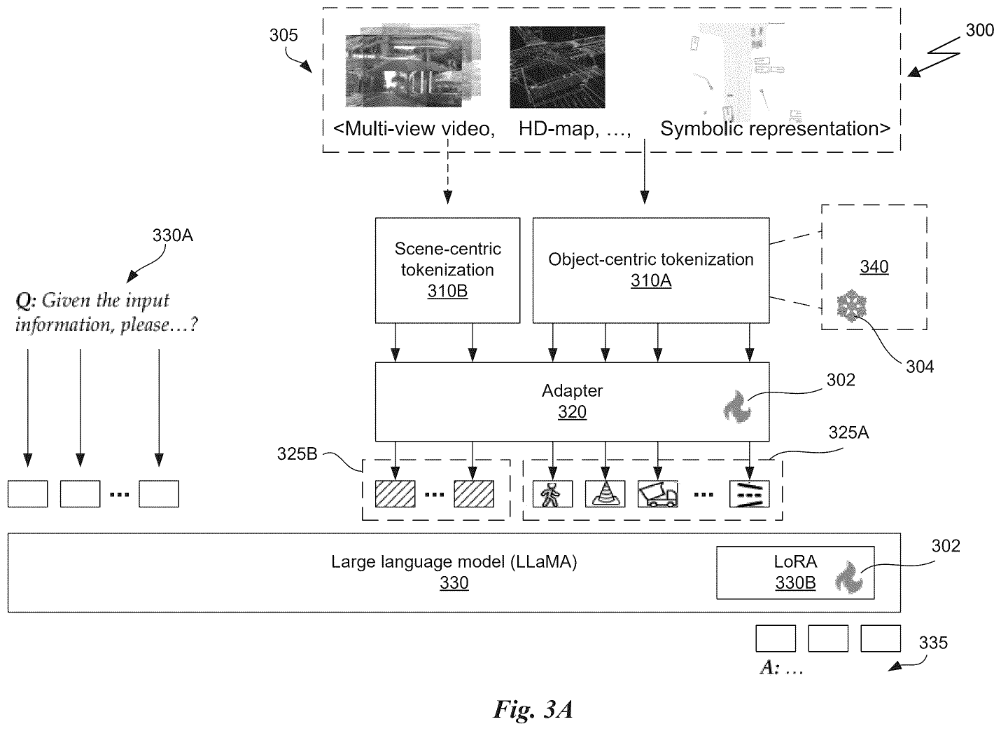

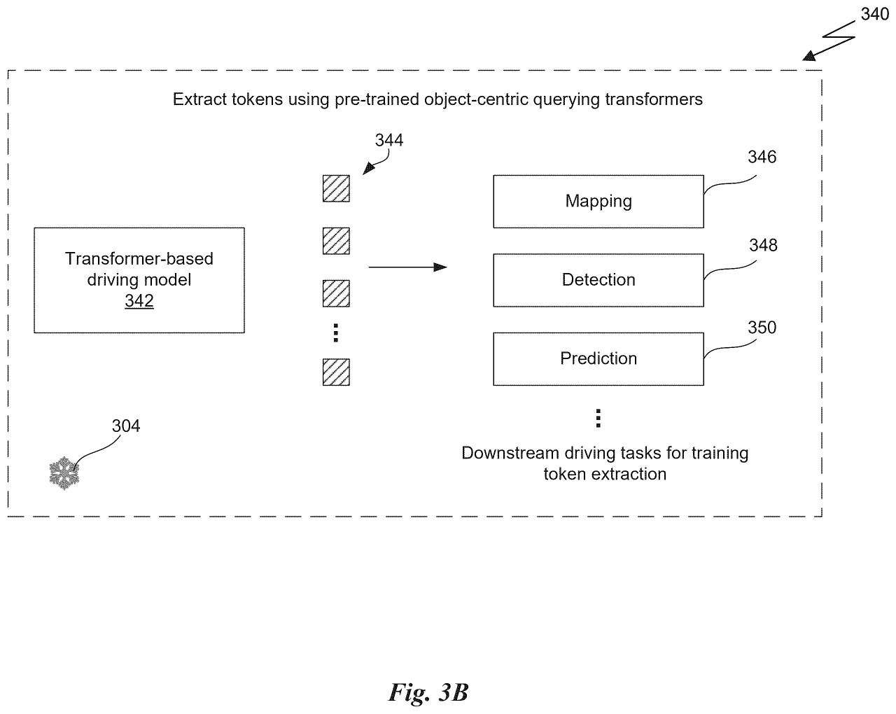

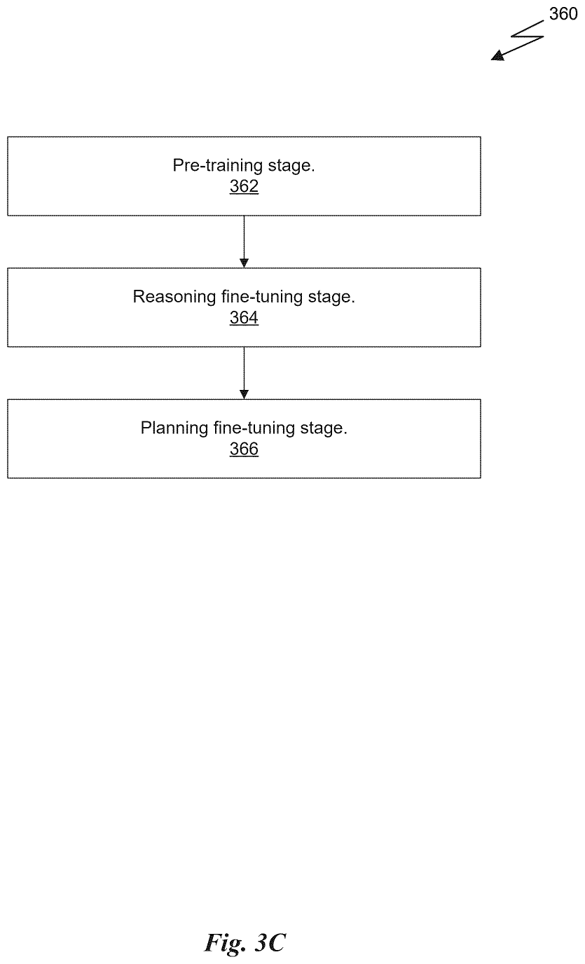

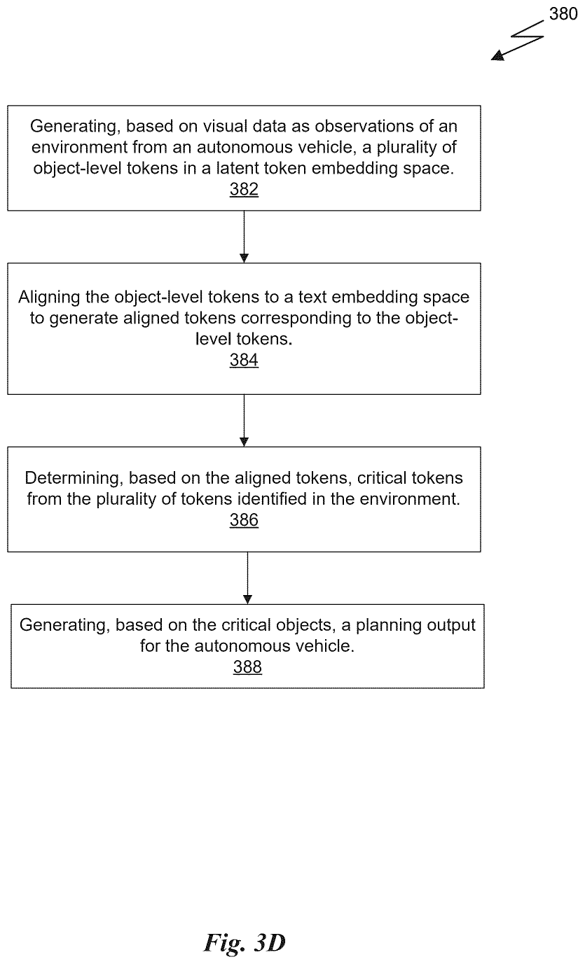

FIG. 3A illustrates a block diagram of a model 300 according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the model 300 is within the scope and spirit of embodiments of the present disclosure. The model 300 implements, according to at least one embodiment, the framework 100 illustrated in FIG. 1A.

More illustrative information will now be set forth regarding various optional architectures and features with which the foregoing framework/model may be implemented, per the desires of the user. It should be strongly noted that the following information is set forth for illustrative purposes and should not be construed as limiting in any manner. Any of the following features may be optionally incorporated with or without the exclusion of other features described.

As shown in FIG. 3A, the model 300 receives visual input 305 that can include various types, such as multi-view video streams, high-definition (HD) maps, symbolic representations, and more. The multi-view video streams (or frames) can be obtained from sensory data. The HD maps can provide additional map information. The symbolic representations can include parsed state-space information (such as bounding box) of the objects in the driving scene, providing additional grounding information to help the model 300 to complete the requested task.

The model 300 performs object-centric tokenization 310A on the visual input 305. In certain embodiments, the model 300 also performs scene-centric tokenization 310B on the visual input 305. For example, the model 300 applies the tokenizer 110, as shown in FIG. 1A, to generate object-level tokens 115A and/or scene-level tokens 115B. The model 300 aligns the tokens using the adapter 320. In certain embodiments, the adapter 320 includes a first network to align the object-level tokens to generate aligned object-level tokens 325A and a second network to align the scene-level tokens to generated aligned scene-level tokens 325B. However, persons of ordinary skill in the art will understand that a different number of networks can be utilized in the adapter 320 to achieve token alignment and/or other suitable operations.

The model 300 processes the aligned tokens (e.g., 325A and/or 325B) using a LLM 330 with predefined questions 330A. The predefined questions 330A can include the perception, behavior reasoning, and route-conditioned hierarchical planning questions described in the present disclosure (e.g., as shown in FIGS. 2A-2C). The model 300 provides textual output 335 generated by the LLM 330. During training, the output from the LLM 330 can be compared with ground truth, such as the predefined answering from the QA pairs corresponding to the visual input in a constructed training dataset.

In certain embodiments, Large Language Model Meta AI (LLaMA) is used as the backbone of the LLM 330. The LLM 330 incorporates Low-Rank Adaptation (LoRA) 330B for fine-tuning the LLM 330 during training.

As indicated by the fire symbol 302, the adapter 320 and the LLM 330 can be dynamically updated during one or more training stages.

The object-centric tokenization 310A includes various functional modules/components, as shown in the dashed box 340, which will be further elaborated upon with reference to FIG. 3B. At least some of the functional modules/components in the dashed box 340 can be frozen (as indicated by the snowflake symbol” during training at one or more training stages. In certain embodiments, the scene-centric tokenization 310B includes functional modules/components that are similar to or different from those in the object-centric tokenization 310A. In certain embodiments, a scene tokenizer (e.g., including the functional modules/components shown in the dashed box 340) is used to perform the object-centric tokenization 310A and/or the scene-centric tokenization 310B.

FIG. 3B illustrates functional modules/components suitable for use in the model 300 (e.g., in the object-centric tokenization 310A), as shown in FIG. 3A. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the object-centric tokenization 310A is within the scope and spirit of embodiments of the present disclosure.

As shown in FIG. 3B, the object-centric tokenization 310A utilizes a transformer-based driving model 342 to extract tokens 344 based on the visual input 305. In certain embodiments, the transformer-based driving model 342 incorporates some or all of the components of the tokenizer 110 as illustrated in FIG. 1B. For example, the transformer-based driving model 342 can include the track querying transformer 142, the map querying transformer 152, and the prediction querying transformer 172. Some or all of the transformers in the object-centric tokenization 310A can be pre-trained. The tokens 344 are processed by various transformers for different driving tasks, such as mapping 346, detection 348, and prediction 350. The tokens 344 output from the transformers for different driving tasks are concatenated to generate object-level tokens and/or scene-level tokens. In certain embodiments, the token extraction is trained using downstream driving tasks.

In certain embodiments, a traffic agent token is generated based on past state history from one or more traffic agents. The traffic agent token is fed into the LLM 330 with the other tokens to improve the performance of the overall model.

In certain embodiments, the same or separate tokenizers 110 can be to perform the object-centric tokenization 310A and the scene-centric tokenization 310B.

In certain embodiments, the model 300 as depicted in FIG. 3A is trained in three stages: pre-training, reasoning fine-tuning, and planning fine-tuning. The scene tokenizer (e.g., as shown in FIG. 3B) is frozen and LoRA 330B is used to fine-tune the LLM 330.

FIG. 3C illustrates a flowchart of a method 360 for training the model 300, in accordance with an embodiment. Each block of method 360, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 360 is described, by way of example, with respect to the model 300 of FIG. 3A. However, this method may additionally or alternatively be executed by any one system, or any combination of systems, including, but not limited to, those described herein. Furthermore, persons of ordinary skill in the art will understand that any system that performs method 360 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

At block 362, the processor performs pre-training on the model 300. During pre-training (“representation alignment”), LoRA 330B is disabled. The adapter 320 is trained to enhance embedding space alignment between the scene and text tokens (e.g., between the tokens from the tokenizer and the aligned tokens). The perception QAs are used to train the adapter 320 for five epochs with a learning rate of 5e⁻⁴. This training stage aims to enhance representation alignment, allowing the information contained in the visual tokens, or the aligned tokens 325A and/or 325B, to be more effectively extracted by the LLM 330.

At block 364, the processor performs reasoning fine-tuning on the model 300. During reasoning fine-tuning (“reasoning alignment”), the adapter 320 and LoRA 330B are trained together using the reasoning and planning QAs for ten epochs with a learning rate of 1e⁻⁴. This training stage aims to enhance reasoning alignment, enabling the LLM 330 to better identify important objects and understand their interactions.

At block 366, the processor performs planning fine-tuning on the model 300. During planning fine-tuning, the adapter 320 and LoRA 330B are trained together using the planning QAs for another ten epochs to maximize the model's 300 performance on planning, maintaining the learning rate at 1e⁻⁴. This training strategy leverages the pre-trained tokenizer(s) and LLM, further fine-tuning learnable modules (e.g., the adapter 320 and LoRA 330B) implemented in the MM-LLM (e.g., the LLM 330) to achieve the described functionality. This training stage aims to enhance the planning performance.

In certain embodiments, during each training stage, the processor determines a loss based on differences between the predicted answers (e.g., answers generated by the LLM 330) and ground truth answers predefined in the QA pairs, and updates learnable parameters in the model 300 based on the loss. However, it will be noted that other suitable techniques can also be used to optimize the model 300.

FIG. 3D illustrates a flowchart of a method 380 for motion planning for an autonomous vehicle, in accordance with an embodiment. Each block of method 380, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 380 is described, by way of example, with respect to the model 300 of FIG. 3A. However, this method may additionally or alternatively be executed by any one system, or any combination of systems, including, but not limited to, those described herein. Furthermore, persons of ordinary skill in the art will understand that any system that performs method 380 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

At block 382, the processor generates, based on visual data as observations of an environment from the autonomous vehicle, a plurality of object-level tokens in a latent token embedding space. The object-level tokens correspond to a plurality of objects identified in the environment. In certain embodiments, the processor further generates, based on the visual data, a plurality of scene-level tokens in the latent token embedding space. Each scene-level token of the plurality of scene-level tokens provides unstructured scene information corresponding to a portion of the scene. In certain embodiments, the processor further generates one or more traffic agent tokens based on past state history from one or more traffic agents.

At block 384, the processor aligns the object-level tokens to a text embedding space to generate aligned tokens corresponding to the object-level tokens. In certain embodiments, the processor further aligns the scene-level tokens to the text embedding space to generate aligned tokens corresponding to the scene-level tokens.

At block 386, the processor determines, based on the aligned tokens, critical objects from the plurality of objects identified in the environment.

At block 388, the processor generates, based on the critical objects, a planning output for the autonomous vehicle.

### Parallel Processing Architecture

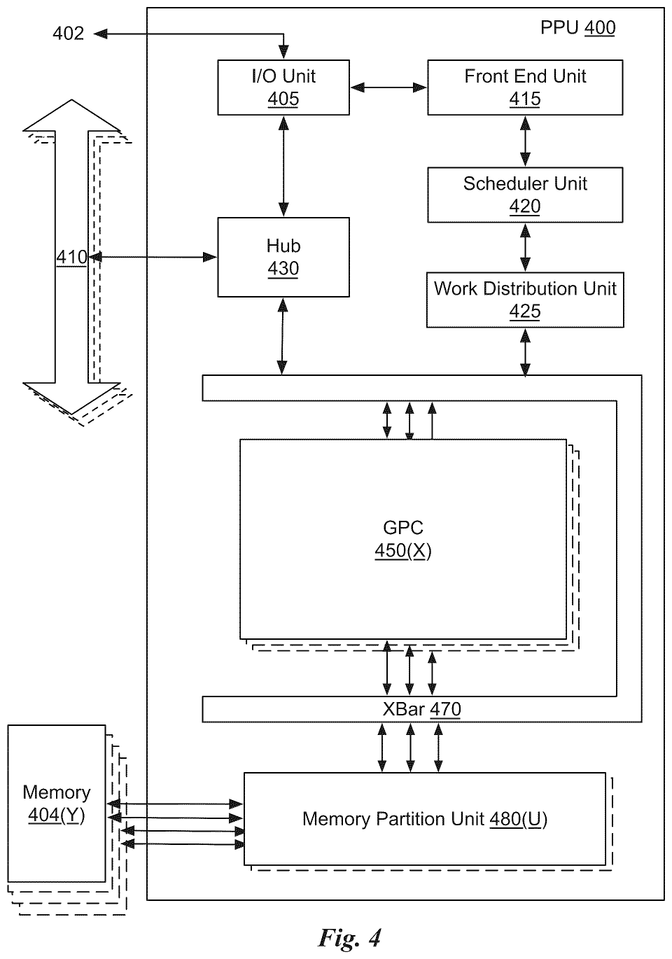

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

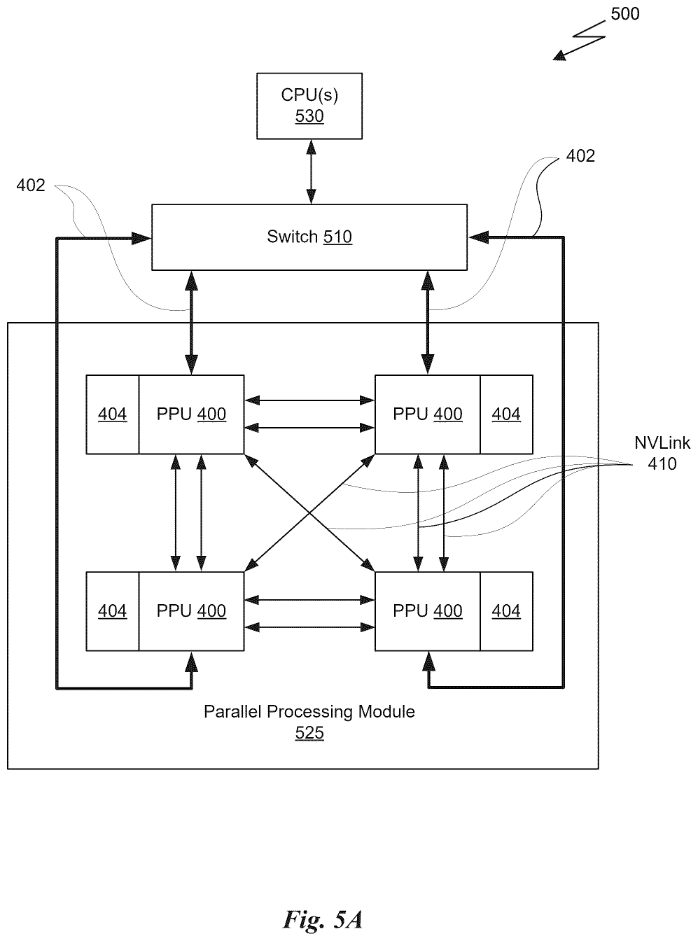

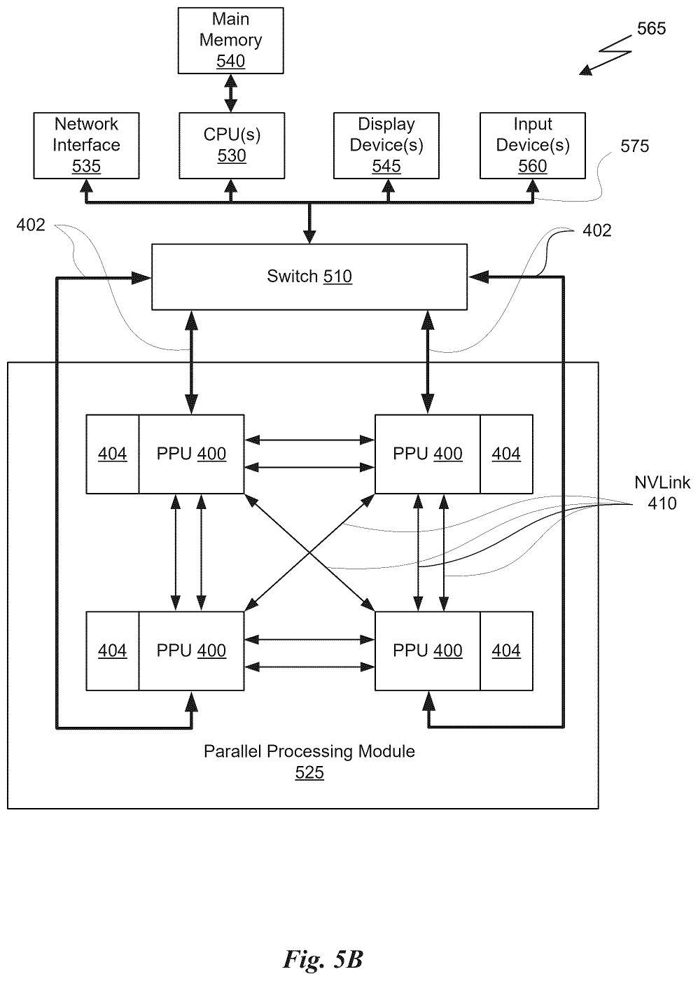

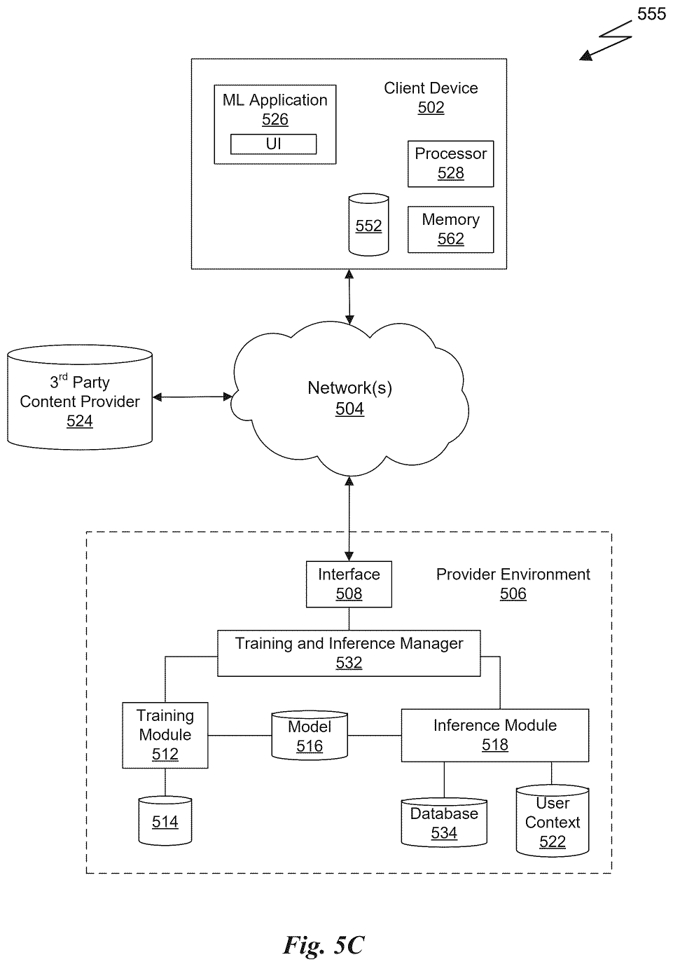

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output

(I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemple Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

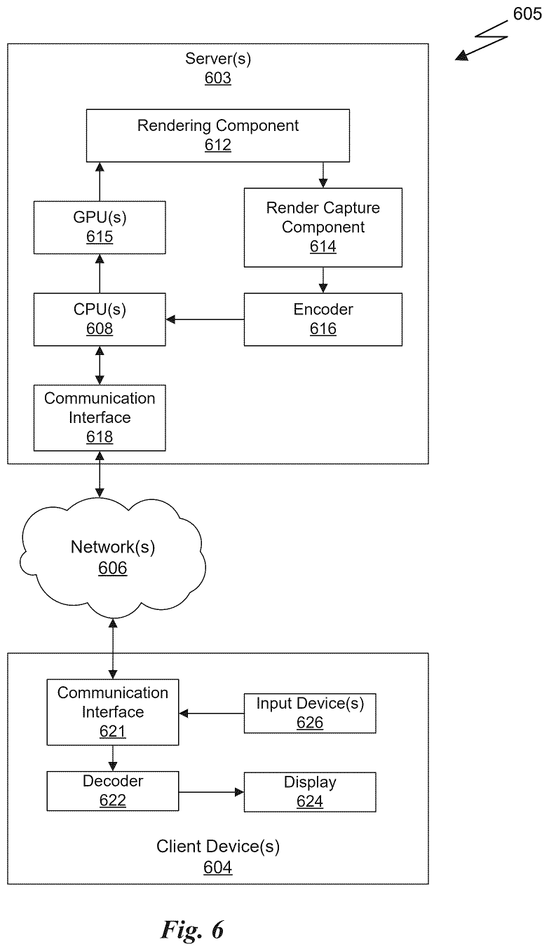

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering-in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A processor comprising:
one or more arithmetic logic units (ALUs) configured to perform, using one or more neural networks, motion planning for an autonomous vehicle, the one or more neural networks comprising:
a tokenizer configured to:
identify, based on visual data obtained from an environment of the autonomous device, a plurality of objects in the environment; and
generate, for the plurality of identified objects, a plurality of object level visual tokens in a latent token embedding space;
an adapter configured to align the object level visual tokens to a text embedding space to generate aligned tokens corresponding to the object level visual tokens; and
a large language model (LLM) configured to:
determine, based on the aligned tokens, critical objects from the plurality of objects identified in the environment; and
generate, based on the critical objects, a planning output for the autonomous vehicle.

2. The processor according to claim 1, wherein the tokenizer is further configured to generate, based on the visual data, a plurality of scene level tokens in the latent token embedding space, each scene level token of the plurality of scene level tokens providing scene information;
wherein the adapter is further configured to align the scene level tokens to the text embedding space to generate aligned tokens corresponding to the scene level tokens; and
wherein the aligned tokens comprise the aligned tokens corresponding to the object level visual tokens and the aligned tokens corresponding to the scene level tokens.

3. The processor according to claim 1, wherein the tokenizer is further configured to generate a traffic agent token based on past state history from one or more traffic agents; and
wherein generating the planning output for the autonomous vehicle is further based on the aligned tokens and the traffic agent token.

4. The processor according to claim 1, wherein the visual data comprises at least one of:
multi-view video frames; or
high-definition (HD) maps,
wherein the tokenizer is configured to identify the plurality of objects in the environment based on the visual data and symbolic representations that are obtained from the visual data.

5. The processor according to claim 1, wherein the one or more neural networks are trained via a training process comprising:
receiving a dataset comprising a plurality of question-answering pairs (OAs), wherein each QA comprises a question and a ground truth answer, and wherein the plurality of OAs comprises perception QAs, reasoning QAs, and planning QAs;
generating predicted answers for questions from the QAs in the dataset;
determining a loss based on differences between the predicted answers and ground truth answers from in the QAs; and
updating learnable parameters in the one or more neural networks based on the loss.

6. The processor according to claim 5, wherein the training process includes:
a first training stage in which a set of perception QAs from the dataset are used for updating learnable parameters in the adapter;
a second training stage in which a set of reasoning QAs and a set of planning QAs from the dataset are used for updating learnable parameters in the adapter and the LLM; and
a third training stage in which the set of planning QAs are used for updating learnable parameters in the adapter and the LLM.

7. The processor according to claim 6, wherein the LLM comprises a low-rank adaptation module, and the LLM is fine-tuned through tuning the low-rank adaptation module.

8. The processor according to claim 1, wherein the tokenizer comprises:
a first querying transformer for extracting features of object tracking;
a second querying transformer for extracting features of map elements; and
a third querying transformer for extracting features of object motion.

9. The processor according to claim 8, wherein a non-map object token is generated by concatenating results from the first querying transformer and the third querying transformer, wherein a map element token is generated based on results from the second querying transformer, and wherein the plurality of object level visual tokens comprise one or more non-map object tokens and one or more map element tokens.

10. The processor according to claim 9, wherein the adapter comprises:
a first adapter network configured to align the one or more non-map object tokens; and
a second adapter network configured to align the one or more map element tokens.

11. The processor according to claim 10, wherein the first adapter network comprises a multilayer perceptron (MLP) adapter network.

12. A system comprising:
one or more processors configured to perform, using one or more neural networks, motion planning for an autonomous vehicle, the one or more neural networks comprising:
a tokenizer configured to:
identify, based on visual data obtained from an environment of the autonomous device, a plurality of objects in the environment; and
generate, for the plurality of identified objects, a plurality of object level visual tokens in a latent token embedding space;
an adapter configured to align the object level visual tokens to a text embedding space to generate aligned tokens corresponding to the object level visual tokens; and
a large language model (LLM) configured to:
determine, based on the aligned tokens, critical objects from the plurality of objects identified in the environment; and
generate, based on the critical objects, a planning output for the autonomous vehicle.

13. The system according to claim 12, wherein the tokenizer is further configured to generate, based on the visual data, a plurality of scene level tokens in the latent token embedding space, each scene level token of the plurality of scene level tokens providing scene information;
wherein the adapter is further configured to align the scene level tokens to the text embedding space to generate aligned tokens corresponding to the scene level tokens; and
wherein the aligned tokens comprise the aligned tokens corresponding to the object level visual tokens and the aligned tokens corresponding to the scene level tokens.

14. The system according to claim 12, wherein the tokenizer is further configured to generate a traffic agent token based on past state history from one or more traffic agents; and
wherein generating the planning output for the autonomous vehicle is further based on the aligned tokens and the traffic agent token.

15. The system according to claim 12, wherein the visual data comprises at least one of:
multi-view video frames; or
high-definition (HD) maps,
wherein the tokenizer is configured to identify the plurality of objects in the environment based on the visual data and symbolic representations that are obtained from the visual data.

16. The system according to claim 12, wherein the one or more neural networks are trained via a training process comprising:
receiving a dataset comprising a plurality of question-answering pairs (OAs), wherein each QA comprises a question and a ground truth answer, and wherein the plurality of OAs comprises perception QAs, reasoning QAs, and planning QAs;
generating predicted answers for questions from the QAs in the dataset;
determining a loss based on differences between the predicted answers and ground truth answers from in the QAs; and
updating learnable parameters in the one or more neural networks based on the loss.

17. The system according to claim 16, wherein the training process includes:
a first training stage in which a set of perception QAs from the dataset are used for updating learnable parameters in the adapter;
a second training stage in which a set of reasoning QAs and a set of planning QAs from the dataset are used for updating learnable parameters in the adapter and the LLM; and
a third training stage in which the set of planning QAs are used for updating learnable parameters in the adapter and the LLM.

18. The system according to claim 17, wherein the LLM comprises a low-rank adaptation module, and the LLM is fine-tuned through tuning the low-rank adaptation module.

19. The system according to claim 12, wherein the tokenizer comprises:
a first querying transformer for extracting features of object tracking;
a second querying transformer for extracting features of map elements; and
a third querying transformer for extracting features of object motion.

20. The system according to claim 19, wherein a non-map object token is generated by concatenating results from the first querying transformer and the third querying transformer, wherein a map element token is generated based on results from the second querying transformer, and wherein the plurality of object level visual tokens comprise one or more non-map object tokens and one or more map element tokens.

21. The system according to claim 20, wherein the adapter comprises:
a first adapter network configured to align the one or more non-map object tokens; and
a second adapter network configured to align the one or more map element tokens.

22. The system according to claim 21, wherein the first adapter network comprises a multilayer perceptron (MLP) adapter network.

23. A machine-readable medium having stored thereon a set of instructions, which if performed by one or more processors, cause the one or more processors to:
generate, by one or more neural networks, based on visual data as observations of an environment from the autonomous device, object level visual tokens in a latent token embedding space, the object level visual tokens corresponding to a plurality of objects identified in the environment;
align, by the one or more neural networks, the object level visual tokens to a text embedding space to generate aligned tokens corresponding to the object level visual tokens;
determine, by the one or more neural networks, based on the aligned tokens, critical objects from the plurality of objects identified in the environment; and
generate, by the one or more neural networks, based on the critical objects, a planning output for the autonomous vehicle.

24. The machine-readable medium according to claim 23, causing the one or more processors to further:
generate, by the one or more neural networks, based on the visual data, a plurality of scene level tokens in the latent token embedding space, each scene level token of the plurality of scene level tokens providing scene information; and
align, by the one or more neural networks, the scene level tokens to the text embedding space to generate aligned tokens corresponding to the scene level tokens,
wherein the aligned tokens comprise the aligned tokens corresponding to the object level visual tokens and the aligned tokens corresponding to the scene level tokens.

25. The machine-readable medium according to claim 23, causing the one or more processors to further:
generate, by the one or more neural networks, a traffic agent token based on past state history from one or more traffic agents,
wherein generating the planning output for the autonomous vehicle is further based on the aligned tokens and the traffic agent token.

26. The machine-readable medium according to claim 23, wherein the visual data comprises at least one of:
multi-view video frames; or
high-definition (HD) maps,
wherein the plurality of objects in the environment are identified based on the visual data or on symbolic representations that are obtained from the visual data.

27. The machine-readable medium according to claim 23, causing the one or more processors to train the one or more neural networks via a training process comprising:
receiving a dataset comprising a plurality of question-answering pairs (OAs), wherein each QA comprises a question and a ground truth answer, and wherein the plurality of OAs comprises perception QAs, reasoning QAs, and planning QAs;
generating predicted answers for questions from the QAs in the dataset;
determining a loss based on differences between the predicted answers and ground truth answers from in the QAs; and
updating learnable parameters in the one or more neural networks based on the loss.

28. The machine-readable medium according to claim 27, wherein the training process includes:
a first training stage in which a set of perception QAs from the dataset are used for updating learnable parameters in an adapter of the one or more networks, wherein the adapter aligns the object level visual tokens to the text embedding space to generate aligned tokens;
a second training stage in which a set of reasoning QAs and a set of planning QAs from the dataset are used for updating learnable parameters in the adapter and a large language model (LLM), wherein the LLM receives the aligned tokens as input; and
a third training stage in which the set of planning QAs are used for updating learnable parameters in the adapter and the LLM.

29. A method for motion planning for an autonomous vehicle, comprising:
generating, by one or more neural networks, based on visual data as observations of an environment from the autonomous device, object level visual tokens in a latent token embedding space, the object level visual tokens corresponding to a plurality of objects identified in the environment;
aligning, by the one or more neural networks, the object level visual tokens to a text embedding space to generate aligned tokens corresponding to the object level visual tokens;
determining, by the one or more neural networks, based on the aligned tokens, critical objects from the plurality of objects identified in the environment; and
generating, by the one or more neural networks, based on the critical objects, a planning output for the autonomous vehicle.

30. The method according to claim 29, further comprising:
generating, by the one or more neural networks, based on the visual data, a plurality of scene level tokens in the latent token embedding space, each scene level token of the plurality of scene level tokens providing scene information; and
aligning, by the one or more neural networks, the scene level tokens to the text embedding space to generate aligned tokens corresponding to the scene level tokens,
wherein the aligned tokens comprise the aligned tokens corresponding to the object level visual tokens and the aligned tokens corresponding to the scene level tokens.

31. The method according to claim 29, further comprising:
Generating, by the one or more neural networks, a traffic agent token based on past state history from one or more traffic agents,
wherein generating the planning output for the autonomous vehicle is further based on the aligned tokens and the traffic agent token.

32. The method according to claim 29, wherein the visual data comprises at least one of:
multi-view video frames; or
high-definition (HD) maps,
wherein the plurality of objects in the environment are identified based on the visual data or on symbolic representations that are obtained from the visual data.

33. The method according to claim 29, further comprising:
receiving a dataset comprising a plurality of question-answering pairs (OAs), wherein each QA comprises a question and a ground truth answer, and wherein the plurality of OAs comprises perception QAs, reasoning QAs, and planning QAs;
generating predicted answers for questions from the QAs in the dataset;
determining a loss based on differences between the predicted answers and ground truth answers from in the QAs; and
updating learnable parameters in the one or more neural networks based on the loss.

34. The method according to claim 33, further comprising:
a first training stage in which a set of perception QAs from the dataset are used for updating learnable parameters in an adapter of the one or more networks, wherein the adapter aligns the object level visual tokens to the text embedding space to generate aligned tokens;
a second training stage in which a set of reasoning QAs and a set of planning QAs from the dataset are used for updating learnable parameters in the adapter and a large language model (LLM), wherein the LLM receives the aligned tokens as input; and
a third training stage in which the set of planning QAs are used for updating learnable parameters in the adapter and the LLM.
